(19) United States
(12) Patent Application Publication
(10) Pub. No.: US 2025/0052939 A1
(43) Pub. Date: Feb. 13, 2025

(54) FUNCTIONAL IMPRINTED OPTICAL STRUCTURES FOR OPTICAL DEVICES

(71) Applicant: Applied Materials, Inc., Santa Clara, CA (US)

(72) Inventors: Yingnan LIU, Santa Clara, CA (US); Samarth BHARGAVA, Saratoga, CA (US); Kevin MESSER, Mountain View, CA (US); Evan WANG, Palo Alto, CA (US); David Alexander SELL, Santa Clara, CA (US); Simon LORENZO, Santa Clara, CA (US)

(21) Appl. No.: 18/798,061

(22) Filed: Aug. 8, 2024

Related U.S. Application Data
(60) Provisional application No. 63/518,478, filed on Aug. 9, 2023.

(51) Int. Cl. F21V 8/00; G02B 27/00

(52) U.S. Cl. CPC G02B 6/0016; G02B 6/0036; G02B 6/0065; G02B 27/0081

(57) ABSTRACT

Embodiments of the present disclosure include apparatus and methods for optical devices. In one embodiment, a method for forming an optical device generally includes disposing a first material device layer on a substrate, patterning a portion of the first material device layer to form a first plurality of device structures in the first material device layer, disposing a second material device layer on an un-patterned portion of the first device material layer, and patterning the second material device layer to form a second plurality of device structures disposed on the first material device layer.

### RELATED APPLICATIONS

This application claims benefit of and priority to U.S. Provisional Application No. 63/518,478 filed Aug. 9, 2023 which is herein incorporated in it entirety by reference for all purposes.

### BACKGROUND

### Field

Embodiments of the present disclosure generally relate to optical devices for augmented, virtual, and mixed reality. More specifically, embodiments described herein provide for forming optical device structures having blazed or staircase gratings.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Optical devices including waveguide combiners, such as augmented reality waveguide combiners, and flat optical devices, such as metasurfaces, are used to assist in overlaying images. Generated light is propagated through an optical device until the light exits the optical device and is overlaid on the ambient environment. Optical devices may require structures having blazed angles relative to the surface of the optical device substrate. Conventionally, fabricating blazed optical device structures using one or more angled etch tools requires multiple lithographic patterning operations and angled etch steps. The multiple lithographic patterning operations and angled etch steps increase fabrication time and increase cost. Some of the challenges of waveguide display with current grating designs and known materials also include low optical efficiency, stray light, ghost images, and a small Field of View (FOV). In addition, manufacturing current gratings on the same substrate can be a time-consuming process.

Accordingly, what is needed in the art are improved methods of forming optical devices including blazed optical device structures.

### SUMMARY

Embodiments of the present disclosure provide a method. The method generally includes disposing a first device material layer over a substrate, the first device material layer being a different material from the substrate and patterning a portion of the first device material layer to form a first plurality of device structures in a top surface of the first device material layer. In some embodiments, the first plurality of device structures comprise a first plurality of gratings and a second plurality of gratings. The method also includes disposing a second device material layer on the top surface of a portion of the first device material layer and patterning the second device material layer with a nanoimprint lithography process to form a second plurality of device structures in the second material layer disposed on the first device material layer. In some embodiments, the second plurality of device structures comprise a third plurality of gratings having a grating depth extending from the top surface of the first device material layer to a top surface of the third plurality of gratings. In some embodiments, the second device material layer comprises an uncured imprintable material for receiving a master stamp of the nanoimprint lithography process. In some embodiments, the third plurality of gratings comprises a plurality of blazed device structures or a plurality of staircase device structures.

In another embodiment of the present disclosure, an optical device is provided. The optical device generally includes a substrate and a first device material layer disposed on the substrate, the first device material layer comprising a material different from the substrate. The optical device also includes a first plurality of device structures formed in a portion of the first device material layer and a second plurality of device structures disposed on an unpatterned portion of the first device material layer. In some embodiments, the first plurality of device structures comprises a first plurality of gratings and a second plurality of gratings. In some embodiments, the first plurality of gratings correspond to a pupil expansion grating of a waveguide combiner and the second plurality of gratings correspond to an output coupling grating of the waveguide combiner. In some embodiments, the second plurality of device structures comprises a third plurality of gratings having a grating depth extending from the top surface of the first device material layer to a top surface of the third plurality of gratings. In some embodiments, the third plurality of gratings correspond to an input coupling grating of a waveguide combiner and comprises a plurality of blazed device structures or a plurality of staircase device structures. In other embodiments, the optical device may also include a metal coating layer disposed on the second plurality of device structures.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, as the disclosure may admit to other equally effective embodiments.

FIG. 1A is a perspective, frontal view of an optical device according to embodiments described herein.

FIG. 1B is a schematic cross-sectional view of a plurality of device structures of an optical device according to embodiments described herein.

FIG. 1C is a schematic cross-sectional view of a blazed device structure according to embodiments described herein.

FIG. 1D is a schematic cross-sectional view of a plurality of device structures of an optical device according to embodiments described herein.

FIG. 1E is a schematic cross-sectional view of a staircase device structure according to embodiments described herein.

FIG. 2 is a flow diagram illustrating an example method for fabricating an optical device, according to one or more of the embodiments described herein.

FIGS. 3A-3H are schematic side cross-sectional views of a substrate during fabrication of a blazed structure, according to one or more of the embodiments described herein.

FIG. 4 is a flow diagram illustrating an example method for fabricating an optical device, according to one or more of the embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to optical devices for augmented, virtual, and mixed reality. More specifically, embodiments described herein provide apparatus and methods of manufacture for optical devices having imprinted optical device structures disposed on top of a film layer having additional optical device structures integrated therein.

In one embodiment, the optical device is a waveguide combiner with a high-index film disposed on a substrate and a plurality of device structures integrated in/formed in a top surface of a portion of the high-index film. The optical device also includes a plurality of device structures disposed on top of the high-index film on the substrate. In some embodiments, the plurality of device structures disposed on top of the high-index film comprise blazed device structures or staircase device structures configured for coupling and directing light towards the optical device structures integrated in the high-index film. Compared with conventional waveguides, various embodiments discussed herein can advantageously provide higher coupling efficiency, better image quality (e.g., lower ghosting, higher uniformity, etc.), and a simpler manufacturing process.

In one embodiment, the method utilizes an imprint lithography process in combination with other forming techniques, such as lithography patterning and etch processes to form the optical device. In some embodiments, the method uses conventional lithography patterning and etch processes to form the plurality of device structures in the high-index film, and the imprint lithography process to form the plurality of blazed device structures or the plurality of staircase device structures on the high-index film without multiple lithographic patterning steps and angled etch steps. Using imprint lithography in combination with other techniques for forming optical devices using the methods and implementations discussed herein can provide a means for fabricating optical devices with high throughput while also reducing costs.

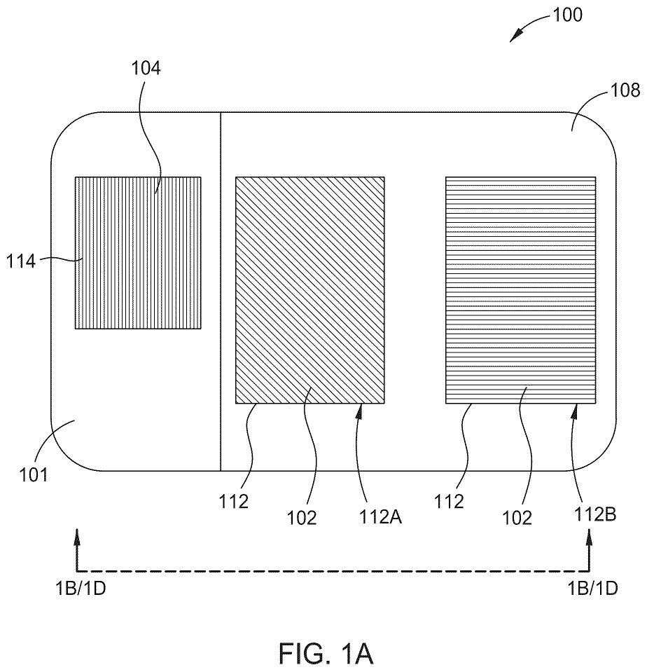

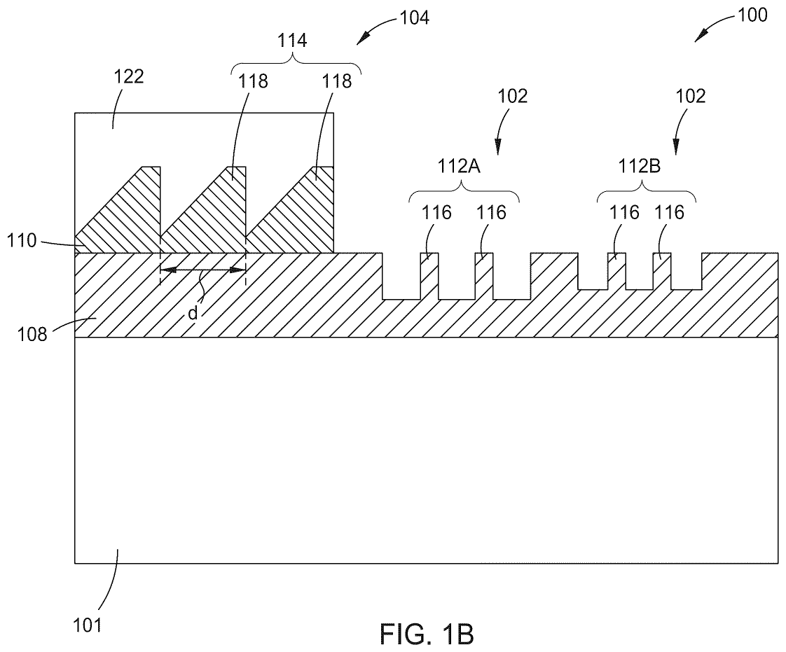

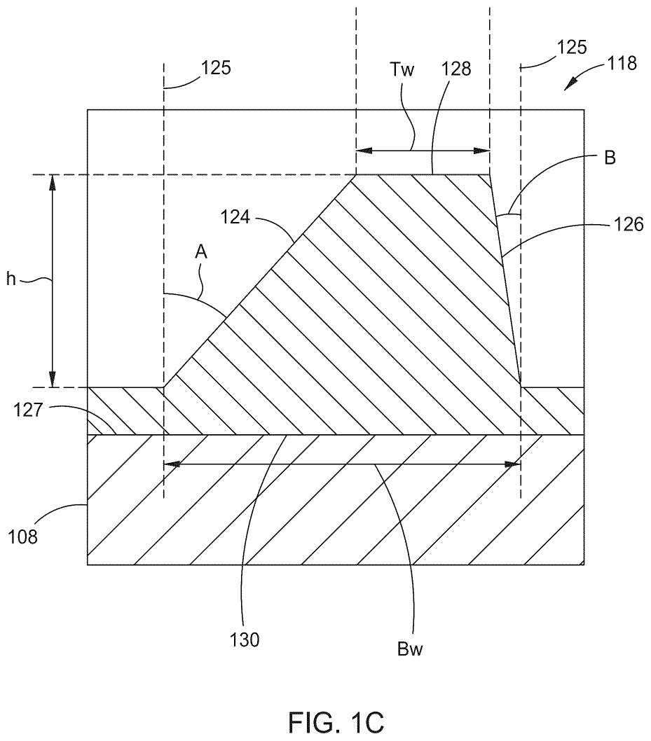

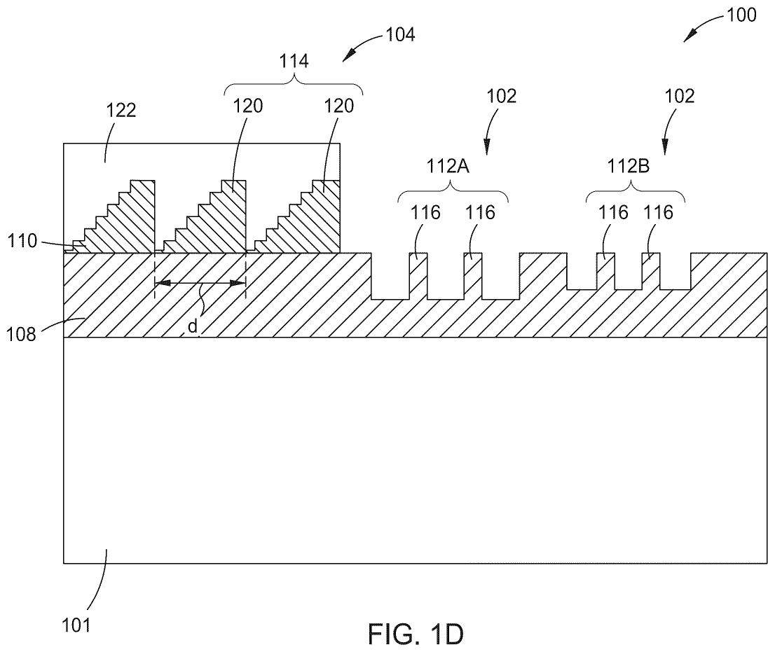

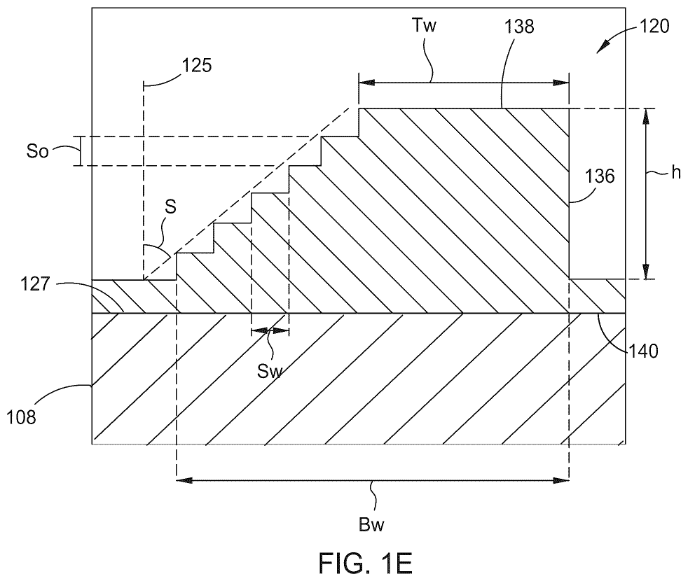

FIG. 1A illustrates a perspective, frontal view of an optical device 100. It is to be understood that the optical device 100 described below is an exemplary optical device. In one embodiment, which can be combined with other embodiments described herein, the optical device 100 is a waveguide combiner, such as an augmented reality waveguide combiner. In another embodiment, which can be combined with other embodiments described herein, the optical device 100 is a flat optical device, such as a meta surface. The optical device 100 includes a first plurality of device structures 102 and a second plurality of device structures 104 disposed on a substrate 101. In an embodiment, the first plurality of device structures 102 is integrated in and/or formed in a portion of a first device material layer 108 disposed on the substrate 101. In an embodiment, the second plurality of device structures 104 is formed in a second device material layer 110 disposed on a top surface of a remaining portion of the first device material layer 108 separate from the first plurality of device structures 102. The first and second plurality of device structures 102, 104 may be nanostructures having sub-micron dimensions, e.g., nano-sized dimensions, such as critical dimensions less than 1 μm.

In one embodiment, which can be combined with other embodiments described herein, regions of the first plurality of device structures 102 correspond to one or more gratings 112, such as a first grating 112A and a second grating 112B. In another embodiment, which can be combined with other embodiments described herein, regions of the second plurality of device structures 104 correspond to a third grating 114. In one embodiment, which can be combined with other embodiments described herein, the optical device 100 is a waveguide combiner that includes at least the first grating 112A corresponding to an intermediate or pupil expansion grating and the second grating 112B corresponding to an output coupling grating. The waveguide combiner according to the embodiment, which can be combined with other embodiments described herein, may include the third grating 114 corresponding to an input coupling grating.

A material of the substrate 101 includes, but is not limited to, one or more of silicon (Si), silicon dioxide (SiO2), germanium (Ge), silicon germanium (SiGe), sapphire, silicon carbide (SiC), lithium niobium oxide (LiNbOx) and high-index transparent materials such as high-refractive-index glass. For example, the substrate 101 includes glass doped with a heavy dopant such as lanthanum (La), zirconium (Zr), zinc (Zn), and the like. The substrate 101 may include other suitable materials, including, but not limited to, amorphous dielectrics, non-amorphous dielectrics, crystalline dielectrics, silicon oxide, polymers, and combinations thereof. In some examples, which can be combined with other embodiments described herein, the substrate 101 includes a transparent material. Suitable examples may include an oxide, sulfide, phosphide, telluride or combinations thereof.

The materials of the substrate 101 may further have rollable and flexible properties. In one example, the material of the substrate 101 includes, but is not limited to, materials having a refractive index between about 1.5 and about 2.4. For example, the substrate 101 may be a doped high index substrate having a refractive index between about 1.7 and about 2.4.

The first device material layer 108 can be disposed over a top surface of an optical device substrate, for example, by a film deposition method on the substrate 101 if present. Any suitable method for deposition of the first device material layer 108 can be used. Examples of suitable thin film deposition methods include a physical vapor deposition (PVD) process (e.g., ion beam sputtering, magnetron sputtering, e-beam evaporation), a chemical vapor deposition (CVD) process, a plasma enhanced chemical vapor deposition (PECVD) process, an atomic layer deposition (ALD) process, an inkjet printing process, or a three-dimensional (3D) printing process.

In some embodiments, which can be combined with other embodiments described herein, the first device material layer 108 includes material different from the material of the substrate 101. In some embodiments, which can be combined with other embodiments described herein, the first device material layer 108 includes but is not limited to, one or more of silicon oxycarbide (SiOC), titanium dioxide (TiO2), silicon dioxide (SiO2), vanadium (IV) oxide (VOx), aluminum oxide (Al2O3), aluminum-doped zinc oxide (AZO), indium tin oxide (ITO), tin dioxide (SnO2), zinc oxide (ZnO), tantalum pentoxide (Ta2O5), silicon nitride (Si3N4), zirconium dioxide (ZrO2), niobium oxide (Nb2O5), cadmium stannate (Cd2SnO4), or silicon carbon-nitride (SiCN) containing materials. In some embodiments, which can be combined with other embodiments described herein, the material of the first device material layer 108 may have a refractive index between about 1.5 and about 2.65. In other embodiments, which can be combined with other embodiments described herein, the first device material layer 108 may have a refractive index between about 3.5 and about 4.0.

In some embodiments, which can be combined with other embodiments described herein, the second device material layer 110 comprises an uncured patternable material layer for receiving an imprint pattern of a nanoimprint process to form the second plurality of device structures 104. In some embodiments, the second device material layer 110 is a patternable polymer or resist material including but not limited to, an UV curable adhesive, a thermoplastic material, or other polymer material. The uncured patternable material can be deposited using deposition techniques, such as, for example, jet deposition (e.g., inkjet deposition), coating, spin-coating, spraying, or other pre-metered coating techniques such as slot-die, doctor blade, knife edge, screen, etc.

FIG. 1B illustrates a schematic, cross-sectional view of the optical device 100A, according to certain embodiments. In some embodiments, which can be combined with other embodiments described herein, the first plurality of device structures 102 can include grating device structures having a variety of shapes, such as, for example lines (binary), pillars, slanted lines or pillars, saw-tooth, staircase, blazed, etc. In one embodiment, which can be combined with other embodiments described herein, the first plurality of device structures 102 includes binary device structures 116 of a waveguide combiner, such as an augmented reality waveguide combined.

In one embodiment, which can be combined with other embodiments described herein, the second plurality of device structures 104 are blazed device structures 118 of a waveguide combiner, as shown in FIG. 1B. In other embodiments, the second plurality of optical structures 104 may be staircase shaped device structures or another shape. In the example shown, the waveguide combiner includes binary device structures 116 in the first and second gratings 112A, 112B and blazed device structures 118 in the third grating 114. The third grating 114 corresponds to an input coupling grating of optical device 100 configured for coupling incident light into the optical device 100 and directing the light towards the first grating 112A. The first grating 112A corresponding to an intermediate or pupil expansion grating of optical device 100 can propagate the light through the optical device 100 via total internal reflection. The first grating 112A can then direct the light towards the second grating 112B corresponding to an output coupling grating of optical device 100 which can extract and direct the light out of the optical device 100 and into a viewer's eyes.

In some embodiments, which can be combined with other embodiments described herein, the optical device 100 includes a metal coating 122 deposited on the second plurality of device structures 104. The metal coating 122 can be of any suitable shape. In some embodiments, which can be combined with other embodiments, the metal coating 122 forms a conformal coating over or on the blazed device structures 118 or the staircase device structures 120. In other embodiments, which can be combined with other embodiments, the metal coating 122 forms a blanket coating or overfills the patterns defined by the blazed device structures 118 or the staircase device structures 120. In some embodiments, which can be combined with other embodiments described herein, the metal coating 122 comprises, consists of, or consists essentially of one or more metals. The metal coating 122 includes but is not limited to transparent conducting materials (e.g., indium-tin-oxide (ITO), fluorine doped tin oxide (FTO), or doped zinc oxide), silver, aluminum, gold, or a combination thereof. The metal coating 122 has a thickness that is greater than the skin depth of the metal in the operating spectrum. In some embodiments, which can be combined with other embodiments described herein, the metal coating 122 has a thickness of at least about 200 nanometers.

FIG. 1C illustrates a schematic, cross-sectional view of a blazed device structure 118, according to certain embodiments of the present disclosure. Each of the blazed device structures 118 includes a first blazed surface 124, a second blazed surface 126 opposite the first blazed surface 124, a top surface 128, a bottom surface 130 opposite the top surface 128, a grating depth “h”, a top width “T_{w}”, a bottom width “B_{w},” a grating period, and a linewidth “d” (shown in FIG. 1B). The grating depth “h” extending between a top surface 127 of the first device material layer 108 and the top surface 128, can be from about 10 nanometers to about 500 nanometers; for example, from about 80 nanometers to about 150 nanometers; or from about 20 nanometers to about 70 nanometers. The first blazed surface 124 forms a blazed angle “A.” The blazed angle A can be from about 50 degrees to about 80 degrees relative to an axis 125 perpendicular with a top surface 127 of the first device material layer 108, for example, from about 60 degrees to about 70 degrees from the perpendicular axis 125. The second blazed surface 126 forms a blazed angle “B.” The blazed angle B can be from about 0 degrees to about 40 degrees relative to the axis 125, for example, from about 10 degrees to about 30 degrees from perpendicular axis 125. A top duty cycle is defined as

$$\frac{top width Tw}{grating period} .$$

The top duty cycle can be from about 0% to about 40%, for example, from about 15% to about 35%. In one embodiment, the grating period can be from about 250 nanometers to about 500 nanometers; for example, from about 300 nanometers to about 400 nanometers. A bottom duty cycle is defined as

$$\frac{bottom width {B}_{W}}{grating period} .$$

The bottom duty cycle can be from about 60% to about 100%, for example, from about 70% to about 90%.

In one embodiment, which can be combined with other embodiments described herein, the blazed angles A and/or B of two or more blazed device structures 118 are different. In another embodiment, which can be combined with other embodiments described herein, the blazed angles A and/or B of two or more blazed device structures 118 are the same. In one embodiment, which can be combined with other embodiments described herein, the grating depth h of two or more blazed device structures 118 are different. In another embodiment, which can be combined with other embodiments described herein, the grating depth h of two or more blazed device structures 118 are the same. In one embodiment, which can be combined with other embodiments described herein, the linewidth d corresponds to the distance between the first blazed surfaces 124 of adjacent blazed device structures 118. In one embodiment, which can be combined with other embodiments described herein, the linewidth d of two or more blazed device structures 118 are different. In another embodiment, which can be combined with other embodiments described herein, the linewidths d of two or more blazed device structures 118 are the same.

FIG. 1D illustrates a schematic, cross-sectional view of an optical device 100B, according to certain embodiments. In some embodiments, In another embodiment, which can be combined with other embodiments described herein, the second plurality of device structures 104 are staircase device structures 120 of a waveguide combiner, as shown in FIG. 1D. In the example shown, the waveguide combiner includes the binary device structures 116 in the first and second gratings 112A, 112B corresponding to a pupil expansion and an output coupling grating, respectively, of the optical device 100. In the example shown, the third grating 114 corresponding to an input coupling grating of the optical device 100 are staircase device structures 120 configured for coupling incident light into the optical device 100 and directing the light towards the first grating 112A.

FIG. 1E illustrates a schematic, cross-sectional view of a staircase device structure 120 according to certain embodiments of the present disclosure. Each of the staircase device structures 120 includes a stepped surface 132 having a plurality of steps 134, a sidewall 136, a top surface 138, a bottom surface 140 opposite the top surface 138, a grating depth “h”, a top width “T_{w}”, a step width “S_{W}”, a step number “N_{S}”, a bottom width “B_{w}”, a step depth “S_{D}”, and a linewidth “d.” In some embodiments, the grating depth extending between a top surface of the first device material layer 108 and the top surface 138 can be from about 10 nanometers to about 500 nanometers; for example, from about 80 nanometers to about 150 nanometers; or from about 20 nanometers to about 70 nanometers. In some embodiments, the grating depth h corresponds to the height of the sidewall 136. In some embodiments, the number of steps Nₛ of the stepped surface 132 includes between 2 steps and about 100 steps; such as about 3 steps and about seven 10 steps. In one embodiment, the stepped surface 132 includes six steps, as illustrated. In one embodiment, the stepped surface 132 forms a staircase angle “S.” The staircase angle S can be from about 40 degrees to about 80 degrees relative to the axis 125 perpendicular with the top surface 127 of the first device material layer 108, for example, from about 60 degrees to about 70 degrees from perpendicular axis 125.

A top duty cycle of each of the staircase device structures 120 is defined as

$$\frac{top width Tw}{grating period} .$$

The top duty cycle can be from about 0% to about 40%, for example, from about 15% to about 35%. In one embodiment, the grating period can be from about 200 nanometers to about 400 nanometers; for example, from about 230 nanometers and about 280 nanometers; or from about 300 nanometers and about 370 nanometers. A bottom duty cycle is defined as

$$\frac{bottom width {B}_{W}}{grating period} .$$

The bottom duty cycle can be from about 60% to about 100%, for example, from about 70% to about 90%.

In one embodiment, which can be combined with other embodiments described herein, the step depth S_{D} corresponds to the distance between a top surface of adjacent steps 134 in a staircase device structure 120. In one embodiment, which can be combined with other embodiments described herein, the step depth Sp of two or more steps 134 are different. In another embodiment, which can be combined with other embodiments described herein, the step depth Sp of two or more steps 134 are the same. In one embodiment, which can be combined with other embodiments described herein, the step width S_{W} corresponds to the width of the top surface of each step 134 between the top surface 138 and the bottom surface 140 of each staircase device structure 120. In one embodiment, which can be combined with other embodiments described herein, the step depth S_{D} of two or more steps 134 are different. In another embodiment, which can be combined with other embodiments described herein, the step depth S_{D} of two or more steps 134 are the same.

In one embodiment, which can be combined with other embodiments described herein, the linewidth d corresponds to the distance between the sidewalls 136 of adjacent staircase device structures 120. In one embodiment, which can be combined with other embodiments described herein, the linewidth d of two or more staircase device structures 120 are different. In another embodiment, which can be combined with other embodiments described herein, the linewidths d of two or more staircase device structures 120 are the same. In one embodiment, which can be combined with other embodiments described herein, the staircase angle S of two or more staircase device structures 120 are different. In another embodiment, which can be combined with other embodiments described herein, the staircase angle S of two or more staircase device structures 120 are the same. In one embodiment, which can be combined with other embodiments described herein, the grating depth h of two or more staircase device structures 120 are different. In another embodiment, which can be combined with other embodiments described herein, the grating depth h of two or more staircase device structures 120 are the same.

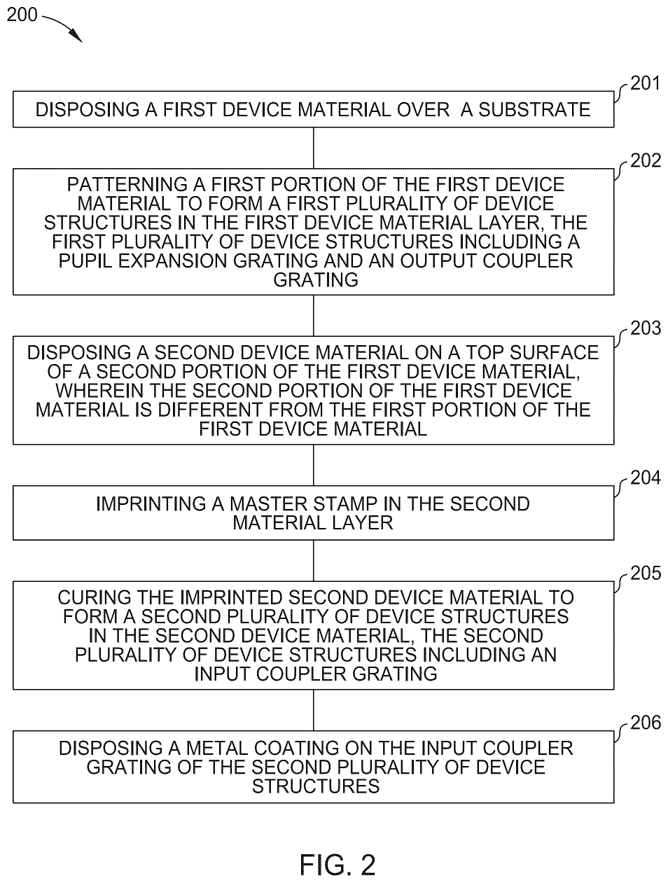

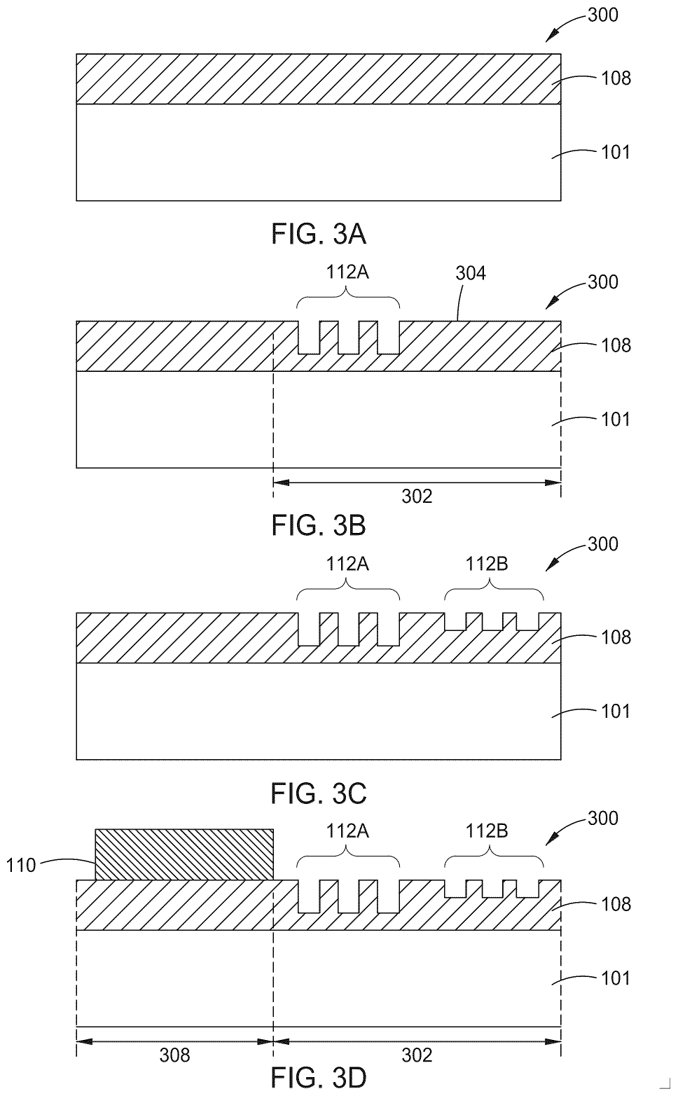

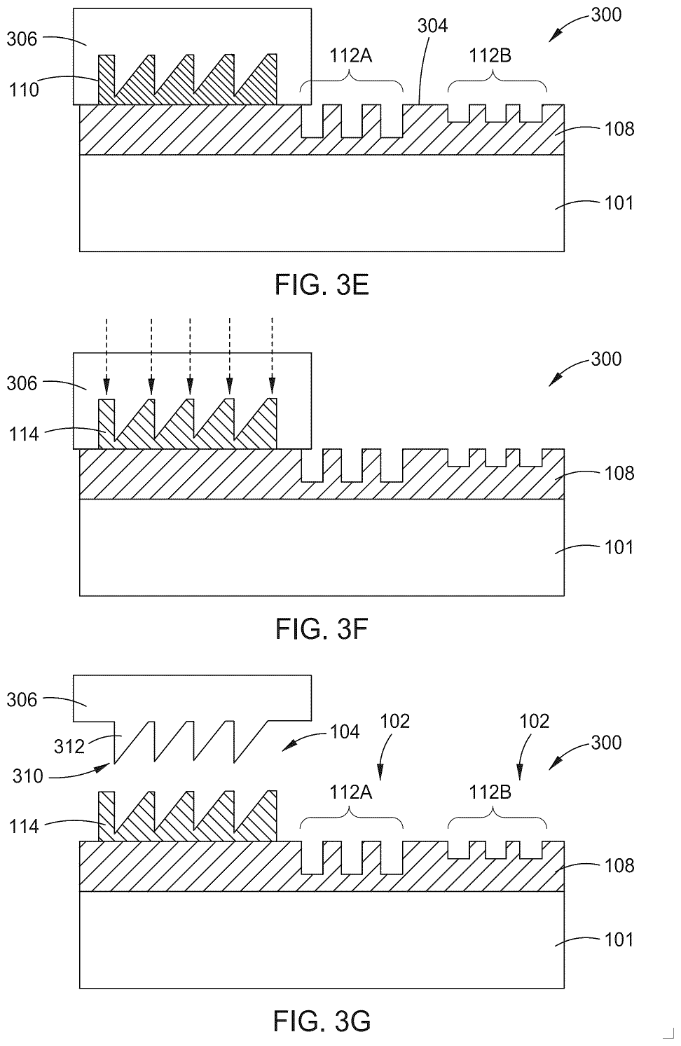

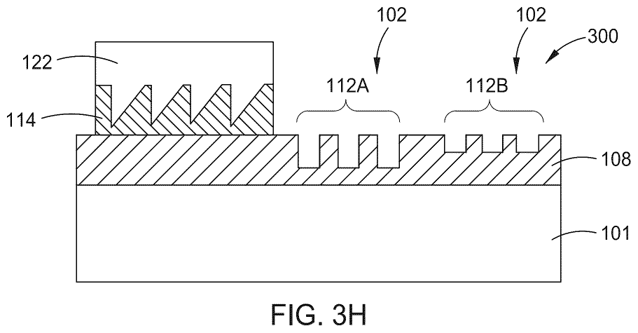

FIG. 2 is a flow diagram of a method 200 for forming an optical device having a first plurality of device structures 102 and a second plurality of device structures 104, according to certain embodiments. FIGS. 3A-3H are schematic, cross sectional views of an example optical device, such as a waveguide 300 formed during the performance of the method 200. Therefore, FIGS. 2 and 3A-3H are herein described together for clarity.

While FIGS. 3A-3H depict etching the first device material layer 108 such that the first plurality of device structures 102 are disposed on a substrate 101, the substrate 101 may alternatively be directly etched such that the first plurality of device structures 102 are disposed in the substrate 101. In some embodiments, the waveguide 300 may correspond to the optical device 100 in FIG. 1A, optical device 100A in FIG. 1B, and/or optical device 100B in FIG. 1D. In one embodiment, which can be combined with other embodiments described herein, the substrate 101 may correspond to a substrate of a flat optical device to have the first and second plurality of device structures 102,104 formed thereon. In another embodiment, which can be combined with other embodiments described herein, the substrate 101 may correspond to a substrate of a waveguide combiner to have the first and second plurality of device structures 102,104 formed thereon.

Method 200 begins at operation 201 in which a first device material layer 108 is disposed over the substrate 101. As discussed above, in an embodiment, the first device material layer 108 may be disposed on a top surface of the substrate 101 by a film deposition process. For example, the first device material layer 108 may be disposed by one or more of PVD, chemical vapor deposition (CVD), plasma-enhanced CVD (PECVD), flowable CVD (FCVD), atomic layer deposition (ALD), and spin-on processes. The first device material layer 108, as discussed herein, can be a high-index material layer.

In operation 202, a portion 302 of the first device material layer 108 is patterned (etched) to form a first plurality of device structures 102 in a top surface 304 of the first device material layer 108. In some embodiments, the portion 302 of the first device material layer 108 may be patterned via lithographic patterning and a wet or a dry-etch process. In an embodiment, as shown in FIGS. 3B and 3C, the first plurality of device structures 102 patterned in the first device material layer 108 comprises a first grating 112A and a second grating 112B formed in the first device material layer 108. In some embodiments, as discussed herein, the first and second gratings 112A, 112B can include grating device structures having a variety of shapes, such as, for example lines (binary), pillars, slanted lines or pillars, saw-tooth, staircase, blazed, etc. For example, the first and second gratings 112A, 112B can include binary vertical device structures, such as binary device structures 116 shown in FIGS. 1B and 1D.

In some embodiments, the first grating 112A and the second grating 112B may be disposed on the waveguide 300 corresponding to the positioning of a pupil expansion grating and an output coupling grating, respectively. The first grating 112A may therefore be configured to distribute and propagate light via total internal reflection along the waveguide 300 towards the second grating 112B. The second grating 112B in turn may be configured to outcouple light propagating in the waveguide 300 into a viewer's eyes. In certain embodiments, which may be combined with other embodiments herein, the first grating 112A and the second grating 112B are patterned simultaneously in operation 202 to form the first plurality of device structures 102 in the portion 302 of the first device material layer 108. In some embodiments, which may be combined with other embodiments herein, the first grating 112A and the second grating 112B are patterned sequentially in operation 202 to form the first plurality of device structures 102 in the portion 302 of the first device material layer 108.

In operation 203, a second device material layer 110 is disposed over the top surface 304 of an un-patterned portion 308 of the first device material layer 108. As mentioned above, the second device material layer 110 comprises an uncured imprintable material. In some embodiments, the second device material layer 110 can be an imprintable polymer or resist material that may be patterned by a nanoimprint process including but not limited to an UV curable adhesive, UV curable resist, thermoplastic material, or other polymer material. The second device material layer 110, as discussed herein, can be disposed on the first device material layer 108 using deposition techniques, such as a jet deposition (e.g., inkjet deposition) process.

In operation 204, a nanoimprint lithography process is performed to form the second plurality of device structures 104 in the second device material layer 110. Operation 204 generally includes imprinting a master stamp 306 into the second device material layer 110 to form positive waveguide patterns. The master stamp 306 has a negative waveguide pattern 310 with an inverse pattern 312. The inverse pattern 312 includes at least one of an inverse grating portion corresponding to the inverse of the third grating 114.

In certain embodiments, the positive waveguide pattern includes at least one of a plurality of grating patterns such as waveguide grating patterns corresponding to the third grating 114, as shown in FIG. 3E. The same master stamp 306 may be used in subsequent iterations of method 200 described herein when repeating the fabrication process to form the waveguide 300. Use of the same master stamp 306 to form the positive waveguide patterns of the second plurality of device structures 104 enables increased efficiency and higher throughput in fabricating the waveguide 300 due to only needing to manually perform the multiple lithographic patterning steps and angled etch steps to form the master stamp 306.

In yet another embodiment, operation 204 may generally include the patterned second device material layer 110 being imparted on the un-patterned portion of the first device material layer 108 by the master stamp 306 via a printing rather than an imprinting process. The master stamp 306 may be partially coated with the material of the second device material layer 110, wherein master stamp 306 has the characteristic of causing the second device material layer 110 to form a desired pattern on the first device material layer 108. As the master stamp 306 is brought into contact with the first device material layer 108, the second device material layer 110 is transferred or printed onto the first device material layer 108.

After the second device material layer 110 is imprinted with the master stamp 306, in operation 205, the positive waveguide patterns are cured to form the third gratings 114 of the second plurality of device structures 104, as shown in FIG. 3F. The curing process performed generally depends on the material of the second device material layer 110. For example, in some embodiments, the second device material layer 110 comprises a UV curable resist and operation 205 therefore includes exposing the imprinted second device material layer 110 to radiation, such as infrared (IR) radiation or ultraviolet (UV) radiation. In other embodiments, the second device material layer 110 comprises a thermally curable material that may be cured by a solvent evaporation curing process. The solvent evaporation curing process may include thermal heating or infrared illumination heating. After the positive waveguide pattern in the second device material layer 110 is cured, the master stamp 306 is released.

FIG. 3G illustrates a schematic, cross-sectional view after the master stamp 306 has been released at operation 205. In one embodiment, the master stamp 306 can be mechanically removed by a machine tool or by hand peeling as master stamp 306 may be coated with a monolayer of anti-stick surface treatment coating, such as a fluorinated coating. In another embodiment, the master stamp 306 may comprise a polyvinyl alcohol (PVA) material that is water soluble in order for the master stamp 306 to be removed by dissolving the master stamp 306 in water. In yet another embodiment, the master stamp 306 comprises a rigid backing sheet, such as a sheet of glass, to add mechanical strength to maintain the integrity of the master stamp 306 during and after release.

In method 200, the first and second plurality of device structures 102, 104 may be formed in either order. In some embodiments, after the first device material layer 108 is disposed over the substrate 101 in operation 201, operations 203-204 may be performed to form the second plurality of device structures 104 on a portion of the first device material layer 108. After the second device material layer 110 is patterned, operation 202 may then be performed to pattern a remaining portion of the first device material layer 108 not covered by the second device material layer 110 to form the first plurality of device structures 102 in the first device material layer 108.

At operation 206, a metal coating 122 is disposed over the third gratings 114 of the second plurality of device structures 104 as shown in FIG. 3H. The metal coating 122 coats the exposed surfaces of the third gratings 114. The metal coating 122 can be of any suitable shape. In some embodiments, which can be combined with other embodiments, the metal coating 122 forms a conformal coating over or on the third gratings 114. In other embodiments, which can be combined with other embodiments, the metal coating 122 forms a blanket coating or overfills the patterns defined by the third gratings 114. Any suitable deposition method for disposing the metal coating 122 can be used. For example, suitable film deposition methods for disposing the metal coating 122 include physical vapor deposition (PVD) (e.g., ion beam sputtering, magnetron sputtering, or e-beam evaporation), chemical vapor deposition (CVD), plasma enhanced chemical vapor deposition (PECVD), atomic layer deposition (ALD), inkjet printing, or three-dimensional (3D) printing.

As described herein, the third gratings 114 of the second plurality of device structures 104 can be configured to incouple incident light into the waveguide 300. In some embodiments, the metal coating 122 may therefore prevent/reduce reflection of the incoupled light from an opposite surface of the third gratings 114. In other embodiments, an anti-reflecting coating may be deposited over the second plurality of device structures 104 instead of the metal coating 122. The anti-reflecting coating may comprise a material having a refractive index less than the refractive index of the material of the second plurality of device structures 104.

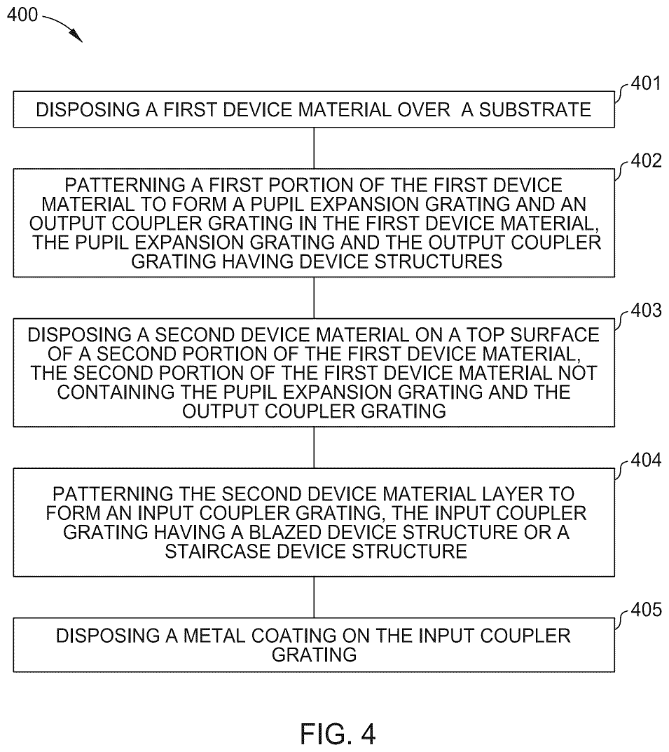

FIG. 4 is a flow diagram of a method 400 for forming an optical device having a first plurality of device structures 102 and a second plurality of device structures 104, according to certain embodiments. Method 400 begins at operation 401 in which a first device material layer 108 is disposed over the substrate 101. The first device material layer 108, as discussed herein, can be a high-index material layer.

In operation 402, the portion 302 of the first device material layer 108 is patterned (etched) to form a first plurality of device structures 102 in a top surface 304 of the first device material layer 108. In some embodiments, the portion 302 of the first device material layer 108 may be patterned via lithographic patterning and a wet or a dry-etch process. In an embodiment, as shown in FIGS. 3B and 3C, the first plurality of device structures 102 patterned in the first device material layer 108 comprises a first grating 112A and a second grating 112B formed in the first device material layer 108. In some embodiments, as discussed herein, the first and second gratings 112A, 112B can include grating device structures having a variety of shapes, such as, for example lines (binary), pillars, slanted lines or pillars, saw-tooth, staircase, blazed, etc.

In some embodiments, the first grating 112A and the second grating 112B may be disposed on the waveguide 300 corresponding to the positioning of a pupil expansion grating and an output coupling grating, respectively. The first grating 112A may therefore be configured to distribute and propagate light via total internal reflection along the waveguide 300 towards the second grating 112B. The second grating 112B in turn may be configured to outcouple light propagating in the waveguide 300 into a viewer's eyes. In certain embodiments, which may be combined with other embodiments herein, the first grating 112A and the second grating 112B are patterned simultaneously in operation 202 to form the first plurality of device structures 102 in the portion 302 of the first device material layer 108. In some embodiments, which may be combined with other embodiments herein, the first grating 112A and the second grating 112B are patterned sequentially in operation 402 to form the first plurality of device structures 102 in the portion 302 of the first device material layer 108.

In operation 403, a second device material layer 110 is disposed over the top surface 304 of an un-patterned portion of the first device material layer 108. As mentioned above, the second device material layer 110 comprises an uncured imprintable material. In some embodiments, the second device material layer 110 can be an imprintable polymer or resist material that may be patterned by a nanoimprint process including but not limited to, an UV curable adhesive, UV curable resist, thermoplastic material, or other polymer material. The second device material layer 110, as discussed herein, can be deposited on the first device material layer 108 using deposition techniques, such as a jet deposition (e.g., inkjet deposition) process.

In operation 404, the second device material layer 110 is patterned to form the second plurality of device structures 104. In some embodiments, the second plurality of device structures 104 can be configured to incouple incident light into the waveguide 300. In an embodiment, the second plurality of device structures 104 patterned in the second device material layer 110 comprises a third grating 114. In some embodiments, as discussed herein, the third grating 114 can include grating device structures having blazed device structures as shown in FIG. 3G, or staircase device structures as shown in FIGS. 1D and 1E.

In some embodiments, patterning the second device material layer 110 in operation 404 may include a nanoimprint lithography process (as described above in method 200). In other embodiments, operation 404 may include use of one or more angled etch tools and multiple lithographic patterning and angled etch steps to form the third gratings 114 of the second plurality of device structures 104.

At operation 405, a metal coating 122 is formed over the third gratings 114 of the second plurality of device structures 104 as shown in FIG. 3H. The metal coating 122 coats the exposed surfaces of the third gratings 114. The metal coating 122 can be of any suitable shape. In some embodiments, which can be combined with other embodiments, the metal coating 122 forms a conformal coating over or on the third gratings 114. In other embodiments, which can be combined with other embodiments, the metal coating 122 forms a blanket coating or overfills the patterns defined by the third gratings 114. Any suitable method for deposition of the metal coating 122 can be used. Examples of suitable thin film deposition methods include physical vapor deposition (PVD) (e.g., ion beam sputtering, magnetron sputtering, or e-beam evaporation), chemical vapor deposition (CVD), plasma enhanced chemical vapor deposition (PECVD), atomic layer deposition (ALD), inkjet printing, or three-dimensional (3D) printing.

As described herein, the third gratings 114 of the second plurality of optical structures 104 can be configured to incouple incident light into the waveguide 300. In some embodiments, the metal coating 122 may therefore function as a mirror or reflecting surface to reflect portions of the incident light from an opposite surface of the third gratings 114 into the waveguide, thereby increasing the efficiency of the incoupling of the incident light by the third gratings 114.

In summation, disposing the second device material layer 110 and forming the second plurality of device structures 104 via nanoimprint lithography before or after forming the first plurality of device structures 104 in the first device material layer 108 disposed in the substrate 101 enables fabrication of the second plurality of device structures 104 with blazed or staircase device structures with higher efficiency and lower cost. As a result, the method of fabricating the blazed or staircase device structures in the second device material layer 110 as described herein therefore eliminates the need to use one or more angled etch tools and multiple lithographic patterning steps and angled etch steps as conventionally used to form blazed and/or staircase device structures, resulting in increased efficiency, lower fabrication time, and lower costs.

While the foregoing is directed to embodiments of the present disclosure, other and further embodiments of the disclosure may be devised without departing from the basic scope thereof, and the scope thereof is determined by the claims that follow.

What is claimed is:

1. A method for forming an optical device, comprising:
disposing a first device material layer over a substrate, the first device material layer being a different material from the substrate;
patterning a portion of the first device material layer to form a first plurality of device structures in a top surface of the first device material layer, the first plurality of device structures comprising a first plurality of gratings and a second plurality of gratings;
disposing a second device material layer on the top surface of an unpatterned portion of the first device material layer, the second device material layer being an uncured imprintable material; and
patterning the second device material layer to form a second plurality of device structures in the second device material layer, the second plurality of device structures comprising a third plurality of gratings,
wherein the third plurality of gratings comprises a plurality of blazed device structures or a plurality of staircase device structures, and each of the third plurality of gratings comprises a grating depth extending from the top surface of the first device material layer to a top surface of each of the respective third plurality of gratings.

2. The method of claim 1, wherein the first plurality of gratings correspond to a pupil expansion grating of a waveguide combiner and the second plurality of gratings correspond an output coupling grating of the waveguide combiner.

3. The method of claim 1, wherein the third plurality of gratings correspond to an input coupling grating of a waveguide combiner.

4. The method of claim 1, further comprising disposing a metal coating on the third plurality of gratings.

5. The method of claim 1, wherein patterning the second device material layer comprises patterning with a nano imprint lithography process comprising:
imprinting a master stamp into the second device material layer, the imprinting stamp comprising a plurality of inverse gratings inverse of the third plurality of gratings of the second plurality of device structures;
subjecting the second device material layer to a cure process;
releasing the master stamp from the second device material layer; and
subjecting the second device material layer to an anneal process.

6. The method of claim 1, wherein the first device material layer comprises a high-index film material having a refractive index between about 1.4 and about 3.5.

7. The method of claim 1, wherein the first device material layer comprises silicon oxycarbide (SiOC), titanium dioxide (TiO2), silicon dioxide (SiO2), vanadium (IV) oxide (VOx), aluminum oxide (Al2O3), aluminum-doped zinc oxide (AZO), indium tin oxide (ITO), tin dioxide (SnO2), zinc oxide (ZnO), tantalum pentoxide (Ta2O5), silicon nitride (Si3N4), zirconium dioxide (ZrO2), niobium oxide (Nb2O5), cadmium stannate (Cd2SnO4), or silicon carbon-nitride (SiCN) containing materials.

8. The method of claim 1, wherein the second device material layer comprises a UV curable adhesive, a UV curable resist, or other UV curable polymer.

9. The method of claim 1, wherein the second device material layer comprises a thermally curable thermoplastic or other thermally curable polymer material.

10. The method of claim 1, wherein patterning the portion of the first device material layer comprises performing a lithographic patterning and etch process.

11. An optical device, comprising:
a substrate;
a first device material layer disposed on the substrate, the first device material layer comprising a material different from the substrate;
a first plurality of device structures formed in a portion of the first device material layer, the first plurality of device structures comprising a first plurality of gratings and a second plurality of gratings;
a second device material layer disposed on a portion of a top surface of the first device material layer; and
a second plurality of device structures formed in the second device material layer, the second plurality of device structures comprising a third plurality of gratings,
wherein the third plurality of gratings comprises a plurality of blazed device structures or a plurality of staircase device structures, and each of the third plurality of gratings comprises a grating depth extending from the top surface of the first device material layer to a top surface of each of the respective third plurality of gratings.

12. The optical device of claim 11, wherein the first plurality of gratings correspond to a pupil expansion grating of a waveguide combiner, and the second plurality of gratings correspond an output coupling grating of the waveguide combiner.

13. The optical device of claim 11, wherein the third plurality of gratings correspond to an input coupling grating of a waveguide combiner.

14. The optical device of claim 11, further comprising a metal coating layer disposed on the third plurality of gratings.

15. The optical device of claim 11, wherein the third plurality of gratings is formed from a nanoimprint lithography process performed on the second device material layer disposed on the top surface of the first device material layer.

16. The optical device of claim 11, wherein the first plurality of gratings and the second plurality of gratings are formed by performing a lithographic patterning and etch process in the first device material layer.

17. The optical device of claim 11, wherein the first device material layer comprises a high-index film material having a refractive index between about 1.4 and about 3.5.

18. The optical device of claim 14, wherein the metal coating layer comprises a reflective metal material.

19. The optical device of claim 11, wherein the first plurality of gratings comprises lines (binary), pillars, slanted lines or pillars, saw-tooth, staircase, or blazed device structures.

20. The optical device of claim 11, wherein the second plurality of gratings comprises lines (binary), pillars, slanted lines or pillars, saw-tooth, staircase, or blazed device structures.
